(19) United States
(12) Patent Application Publication
(10) Pub. No.: US 2013/0089388 A1
(43) Pub. Date: Apr. 11, 2013

(54) Novel Fastening Device

(71) Applicants: Jun Liu, Camas, WA (US); Clifford B. Schrock, Portland, OR (US)

(72) Inventors: Jun Liu, Camas, WA (US); Clifford B. Schrock, Portland, OR (US)

(73) Assignee: SUNMODO CORPORATION, Vancouver, WA (US)

(21) Appl. No.: 13/269,405

(22) Filed: Oct. 7, 2011

(51) Int. Cl. F16B 43/00; F16B 35/00

(52) U.S. Cl. 411/371.2

(57) ABSTRACT

Disclosed is a fastening device for the building construction trade that includes a threaded fastener and a mounting plate. The mounting plate includes a frusto-conical aperture adapted to receive the threaded fastener where the smaller opening of the frusto-conical aperture is on the top surface of the mounting plate where the fastener is seated. The threaded fastener includes a collar portion surrounding the fastener head. The top surface of the mounting plate includes a seating portion surrounding the frusto-conical aperture. The seating portion and the bottom surface of the collar portion are complementary in shape and are both shaped as a section of a spherical surface.

### BACKGROUND

The present disclosure relates to a device for fastening equipment and materials in the building construction trade.

In many construction applications, such as mounting equipment to an outside wall, roof, or assembly of outdoor structures, fastening apparatus used in these applications can require a watertight or water-resistant seal and can be required to provide proper structural loading. For example, fastening apparatus for securing solar photovoltaic panels (PV), solar hot water panels, or other equipment to roof structures often require a fastening device that can properly secure the equipment to the roof and prevent water leakage into the roof structure.

Modern construction techniques often require the use of electric or pneumatic fastening tools for securing fasteners through the fastening apparatus into a building structure. One of the challenges in using fastening tools can be misalignment of the fastener with respect to the fastening apparatus. This misalignment can cause water leakage either immediately or over time. For example, often a fastener seats to a fastening apparatus with an elastomeric washer to provide a watertight seal. However, if the fastener is misaligned, the washer may not seat evenly and therefore not provide a watertight seal. In addition, depending on the design of the fastening apparatus, the misaligned fastener may skew and unseat the base of the fastening apparatus from the building structure. This can cause further water leakage and weaken the structural integrity of the mounting system.

For at least the above stated reasons, it would be desirable to have a fastening device that overcomes some or all of the above stated challenges.

### SUMMARY

This Summary introduces a selection of concepts in simplified form that are described in the Description. The Summary is not intended to identify essential features or limit the scope of the claimed subject matter.

Disclosed is a fastening device for the building construction trade that can help to overcome the problem of leakage from fastener misalignment. The disclosed fastening device can have the additional benefit of improving the overall structural integrity of the mounted equipment, for example, a solar PV system, by providing that the base of the fastening device make full contact with the roof or wall mounting surface over a wide range of fastener misalignment.

The fastening device includes a threaded fastener and a mounting plate. The mounting plate includes a frusto-conical aperture adapted to receive the threaded fastener where the smaller opening of the frusto-conical aperture is on the top surface of the mounting plate where the fastener is seated. The threaded fastener includes a collar portion surrounding the fastener head. The top surface of the mounting plate includes a seating portion surrounding the frusto-conical aperture. The bottom surface of the collar portion and the seating portion are complementary in shape and are both shaped as a section of a spherical surface. The combination of frusto-conical aperture and complementary seating and collar portions allows the fastener to freely pivot before installation while still maintaining equal pressure between the points of contact between the collar portion and the seating portion when the threaded fastener is fixed in place after installation.

In one aspect, the bottom surface of the collar portion has the shape of a concave spherical section. The seating portion has the shape of a convex spherical section that is complementary to the concave shape of the collar portion. In an alternative aspect, the bottom surface of the collar portion has the shape of a convex spherical section. The seating portion has the shape of a concave spherical section that is complementary to convex shape of the collar portion.

In a further aspect, the seating surface is the top surface of an outward projection of the top surface of the mounting plate. The outward projection can form a cylindrical body as illustrated in several embodiments within this disclosure. The cylindrical body either can be threaded in order to accept a standoff or protective cover or can be unthreaded.

The combination of seating portion and frusto-conical aperture, as described, can be applied in plurality to the mounting plate in order to accommodate a plurality of fasteners. In addition, many variations of mounting plate shape are possible and include, but are not limited to flat mounting plates, L-brackets, angle brackets, or hinges.

### DRAWINGS

FIG. 1 shows an embodiment of a fastening device in top perspective exploded view.

FIG. 2 shows the fastening device of FIG. 1 in bottom perspective exploded view.

FIG. 3 shows a top view of the fastening device of FIG. 1.

FIG. 4 shows a sectional view of the fastening device of FIG. 3.

FIG. 5 shows a sectional view of the fastening device of FIG. 3 demonstrating freedom of movement before the fastening device is secured.

FIG. 6 shows an exemplary application, shown in cross section, of the fastening device of FIG. 1 secured to wood roof sheeting and a roof beam.

FIG. 7 shows the exemplary application of the fastening device of FIG. 1, in cross-section, where the fastener is secured at a non-normal angle with respect to the plane of the building or roof surface.

FIG. 8 shows a top view of the fastening device of FIG. 7.

FIG. 9 shows an embodiment of a fastening device in top perspective exploded view.

FIG. 10 shows the fastening device of FIG. 9 in bottom perspective exploded view.

FIG. 11 shows a top view of the fastening device of FIG. 9.

FIG. 12 shows a sectional view of the fastening device of FIG. 11.

FIG. 13 shows a sectional view of the fastening device of FIG. 11 demonstrating freedom of movement before the fastening device is secured.

FIG. 14 shows an exemplary application the fastening device of FIG. 9, shown in cross-section, secured to wood roof sheeting and a roof beam.

FIG. 15 shows the exemplary application of the fastening device of FIG. 9 where the fastener is secured at a non-normal angle with respect to the plane of the building or roof surface.

FIG. 16 shows a top view of the fastening device of FIG. 15 where the fastener is secured against the extreme edge of the fastening plate.

FIG. 17 shows an embodiment of a fastening device in top perspective exploded view.

FIG. 18 shows the fastening device of FIG. 17 in bottom perspective exploded view.

FIG. 19 shows a top view of the fastening device of FIG. 17.

FIG. 20 shows a sectional view of the fastening device of FIG. 19.

FIG. 21 shows a sectional view of the fastening device of FIG. 19 demonstrating freedom of movement before the fastening device is secured.

FIG. 22 shows an exemplary application the fastening device of FIG. 17, in cross-section, secured to wood roof sheeting and a roof beam.

FIG. 23 shows the exemplary application of the fastening device of FIG. 17 where the fastener is secured at a non-normal angle with respect to the plane of the building or roof surface.

FIG. 24 shows a top view of the fastening device of FIG. 23 where the fastener is secured against the extreme edge of the fastening plate.

FIG. 25 shows an embodiment of a fastening device in top perspective exploded view.

FIG. 26 shows the fastening device of FIG. 25 in bottom perspective exploded view.

FIG. 27 shows a top view of the fastening device of FIG. 25.

FIG. 28 shows a sectional view of the fastening device of FIG. 27.

FIG. 29 shows a sectional view of the fastening device of FIG. 27 demonstrating freedom of movement before the fastening device is secured.

FIG. 30 shows an exemplary application the fastening device of FIG. 25, shown in cross-section, secured to wood roof sheeting and a roof beam.

FIG. 31 shows the exemplary application of the fastening device of FIG. 25 where the fastener is secured at a non-normal angle with respect to the plane of the building or roof surface.

FIG. 32 shows a top view of the fastening device of FIG. 31 where the fastener is secured against the extreme edge of the fastening plate.

FIG. 33 shows an embodiment of a fastening device in top perspective exploded view disposed to receive a threaded standoff.

FIG. 34 shows the fastening device and threaded standoff of FIG. 33 in bottom perspective exploded view.

FIG. 35 shows a top view of the fastening device of FIG. 33.

FIG. 36 shows a section view of the fastening device of FIG. 35 assembled with the threaded standoff.

FIG. 37 shows a front perspective view of an embodiment of a fastening device in the form of a mounting bracket.

FIG. 38 shows a top view of the fastening device of FIG. 37.

FIG. 39 shows a sectional view of the fastening device of FIG. 38.

FIG. 40 shows a front perspective view of an embodiment of a hinged fastening device.

FIG. 41 shows a sectional view of the hinged fastening device of FIG. 40.

### DESCRIPTION

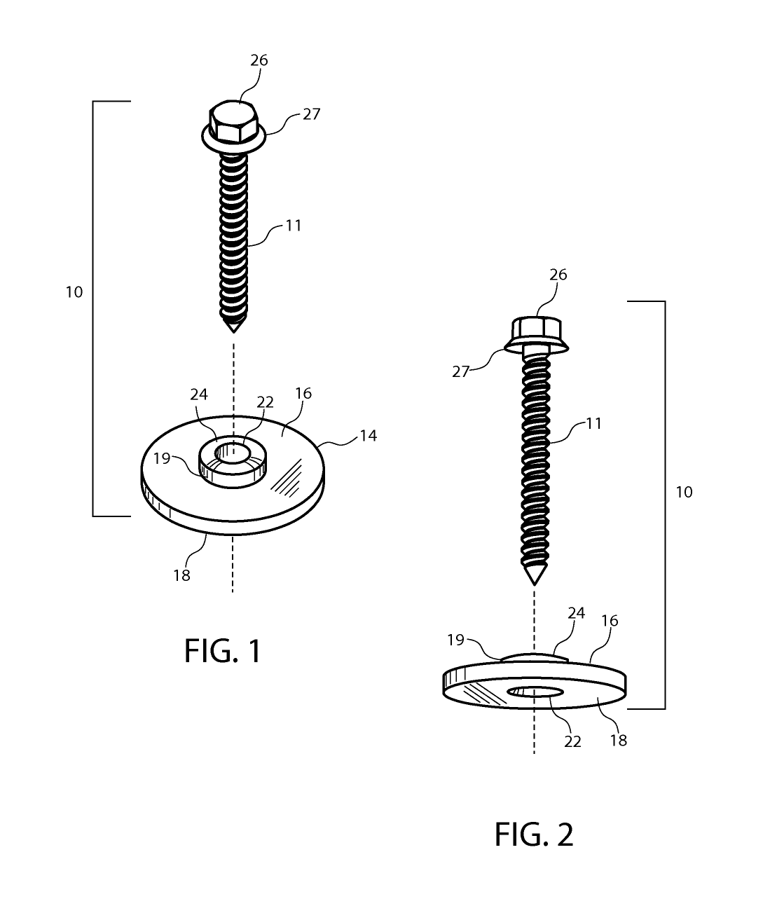

The following description is made with reference to figures, where like numerals refer to like elements throughout the several views. FIG. 1 shows a top perspective exploded view of an embodiment of fastening device 10 that includes a threaded fastener 11 and a mounting plate 14. FIG. 2 shows a bottom perspective exploded view of the embodiment of the fastening device 10.

Referring to FIGS. 1 and 2, the mounting plate 14 includes an upper surface 16 and a lower surface 18. The upper surface 16 includes an upward projection 19. The upward projection 19 includes an aperture 22 that is approximately centric with respect to the upward projection 19. The aperture 22 projects through the lower surface 18. The upward projection 19 includes a top surface or seating portion 24 for seating the threaded fastener 11. The seating portion 24 is convex with respect to the upper surface 16 of the mounting plate 14. The shape of the seating portion 24 forms a section of a sphere. The threaded fastener 11 includes fastener head 26 and a collar portion 27. The bottom surface of the collar portion 27 is concave and has a complementary spherical shape to the seating portion 24 of the upward projection 19.

The threaded fasteners depicted throughout this disclosure have a hexagonal head. This is for convenience of illustration and is not meant to limit the claimed invention. It can readily be understood by those skilled in the art that the fastener head can include other types such slotted, Phillips, Frearson, square (for example, Robertson drive), torx, Allen head, or combination Phillips and slotted. In addition, the threading styles can include, for example, wood screw style, self-tapping, or self-drilling types. In addition, the collar portion is illustrated as being an integrally formed portion of the fastener. It is also possible that the collar is formed separately and but captively held to the fastener head similar to SEM fasteners.

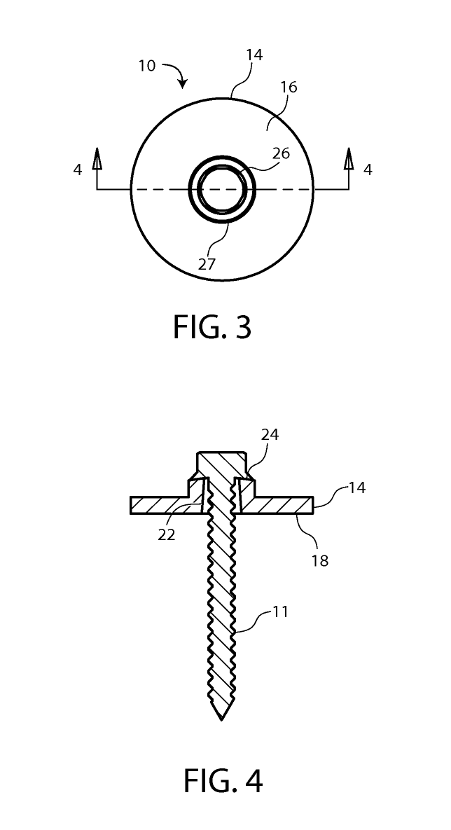

FIG. 3 shows a top view of the fastening device 10 of FIG. 1 showing the upper surface 16 of the mounting plate 14 and the fastener head 26 and collar portion 27. FIG. 4 shows a sectional view of FIG. 3. Referring to FIG. 4, the threaded fastener 11 is shown with the threaded portion or body of the threaded fastener 11 passing through the aperture 22. The aperture 22 is approximately frusto-conical in shape with the smaller diameter opening of the aperture 22 defined by the seating portion 24 and the larger diameter opening of the aperture 22 defined by the lower surface 18 of the mounting plate 14. As illustrated, the aperture 22 is approximately centric with respect to the upward projection 19.

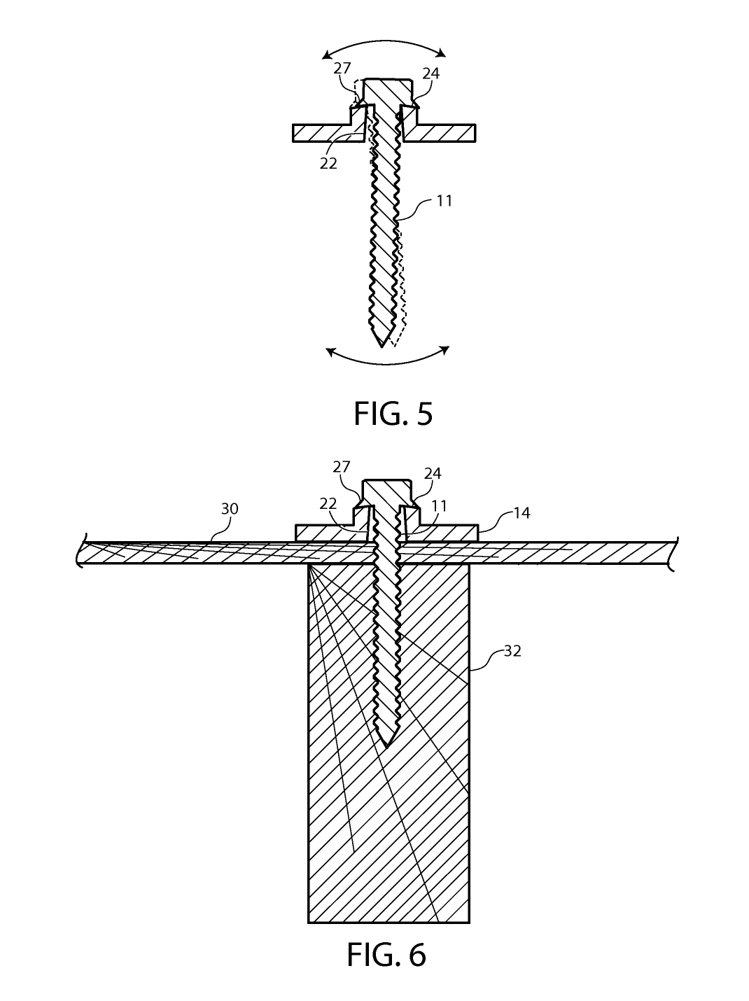

Referring to FIG. 5, the combination of the frusto-conical shape of the aperture 22 and the complementary spherical shape between the bottom surface of the collar portion 27 and seating portion 24, allows the threaded fastener 11 to freely pivot before installation while still maintaining equal pressure between the points of contact between the collar portion 27 and seating portion 24 when threaded fastener 11 is fixed in place after installation.

FIG. 6 shows an illustrative application of the fastening device. The mounting plate 14 is mounted to a building surface 30, for example, roof sheeting or a wall. While the building surface 30 is shown as wood, the building surface 30 can also include metal roof sheeting, or other roof sheeting material. The body of the threaded fastener 11 extends through the aperture 22 into a wood beam 32 or other mounting substrate. In FIG. 6, the threaded fastener 11 is shown secured approximately normal to the plane of the building surface 30. Equal pressure is maintained at the points of contact between the collar portion 27 and seating portion 24 due to the complementary spherical surfaces of the seating portion 24 and the collar portion 27.

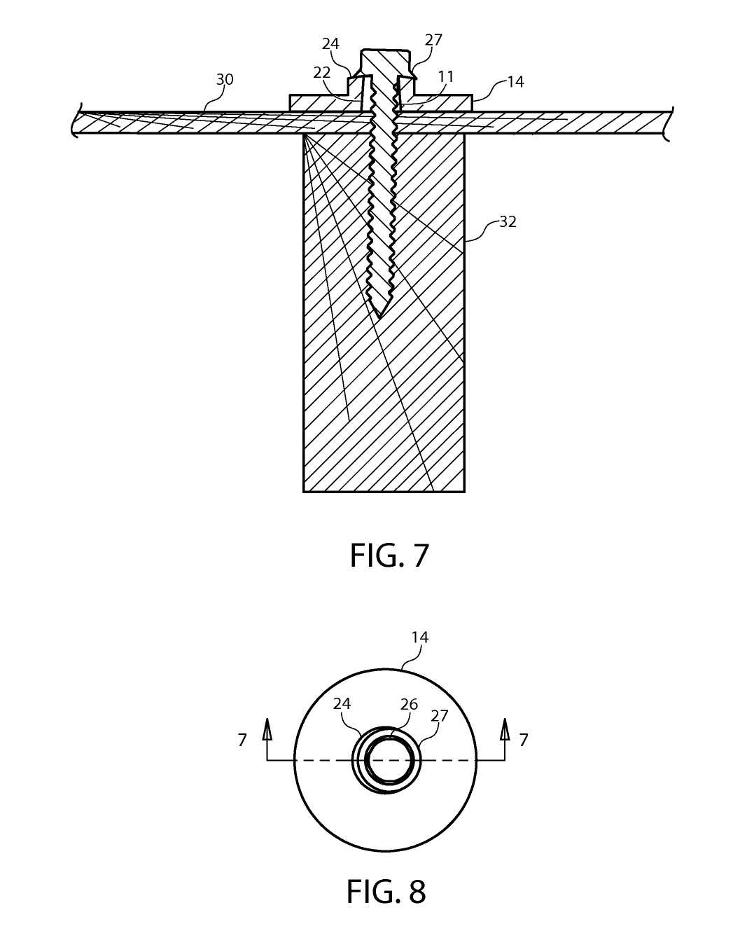

FIG. 7 shows a similar illustrated application of the fastening device of FIG. 6 except the threaded fastener 11 is shown secured at a non-normal angle with respect to the plane of the building surface 30. The frusto-conical shape of the aperture 22 allows the threaded fastener 11 to engage both the building surface 30 and the wood beam 32 at an angle non-normal to surface of the wood beam 32 and building surface 30 without lifting or skewing the mounting plate 14. Equal pressure is maintained at the points of contact between the collar portion 27 and seating portion 24 due to the complementary spherical surfaces of the seating portion 24 and the collar portion 27.

FIG. 8 shows a top view of the fastening device of FIG. 7 showing the mounting plate 14, with the fastener head 26 and collar portion 27 offset to right with respect to the seating portion 24. The aperture 22 remains covered in this arrangement.

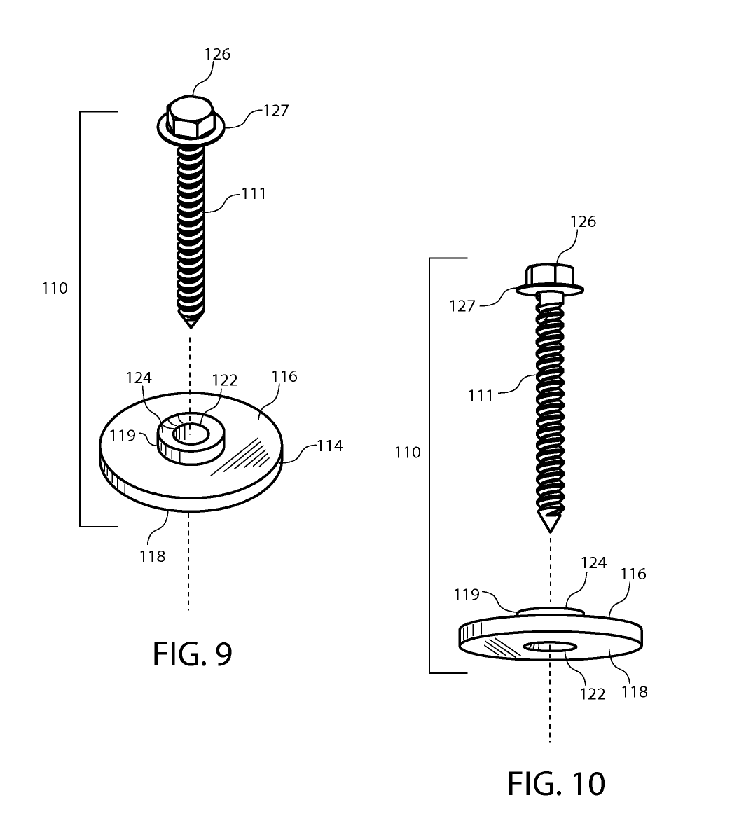

FIGS. 1-8 shows fastening device 10 were the combination of the frusto-conical shape of the aperture 22 and the complementary spherical shape between the bottom surface of the collar portion 27 and seating portion 24 allows the threaded fastener 11 to freely pivot before installation while still maintaining equal pressure between the points of contact between the collar portion 27 and seating portion 24 when the threaded fastener 11 is fixed in place after installation. In another aspect in FIGS. 9-16, instead of the top surface of the projection of the mounting plate, or seating portion, has a concave spherical shape. The bottom surface of the collar portion is convex and has a spherical shape that is complementary to the shape of the top surface of the projection.

FIG. 9 shows a top perspective exploded view of an embodiment of fastening device 110 that includes a threaded fastener 111 and a mounting plate 114. FIG. 10 shows a bottom perspective exploded view of the embodiment of the fastening device 110.

Referring to FIGS. 9 and 10, the mounting plate 114 includes an upper surface 116 and a lower surface 118. The upper surface 116 includes an upward projection 119. The upward projection includes an aperture 122 that is approximately centric with respect to the upward projection 119. The aperture 122 projects through the lower surface 118. The upward projection 119 includes a top surface or a seating portion 124; the seating portion 124 being concave with respect to the upper surface 116 of the mounting plate 114. The shape of the seating portion 124 forms a section of a sphere. The threaded fastener 111 includes fastener head 126 and a collar portion 127. The bottom surface of the collar portion 127 is convex and has an approximately complementary spherical shape to the seating portion 124 of the upward projection 119.

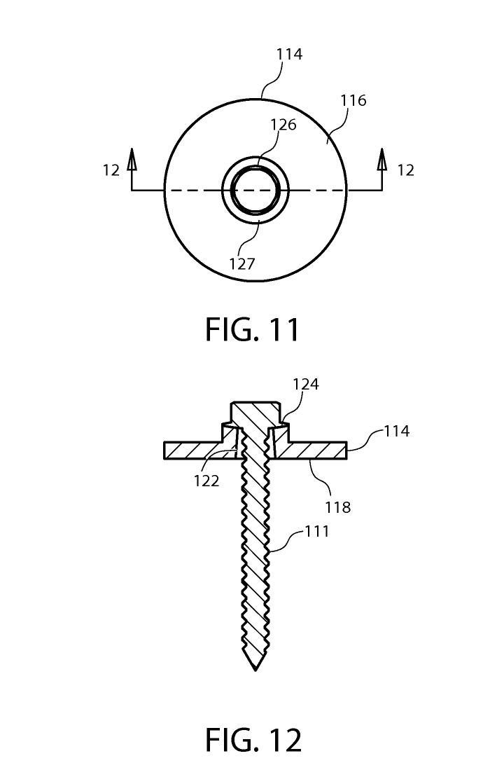

FIG. 11 shows a top view of fastening device 110 of FIG. 9 showing the upper surface 116 of the mounting plate 114 and the fastener head 126 and collar portion 127. FIG. 12 shows a sectional view of FIG. 11. Referring to FIG. 12, the threaded fastener 111 is shown with the threaded portion or body of the threaded fastener 111 passing through the aperture 122. The aperture 122 is approximately frusto-conical in shape with the smaller diameter opening of the aperture 122 defined by the seating portion 124 and the larger diameter opening of the aperture 122 defined by the lower surface 118 of the mounting plate 114. The aperture 122 is approximately centric with respect the mounting plate 114.

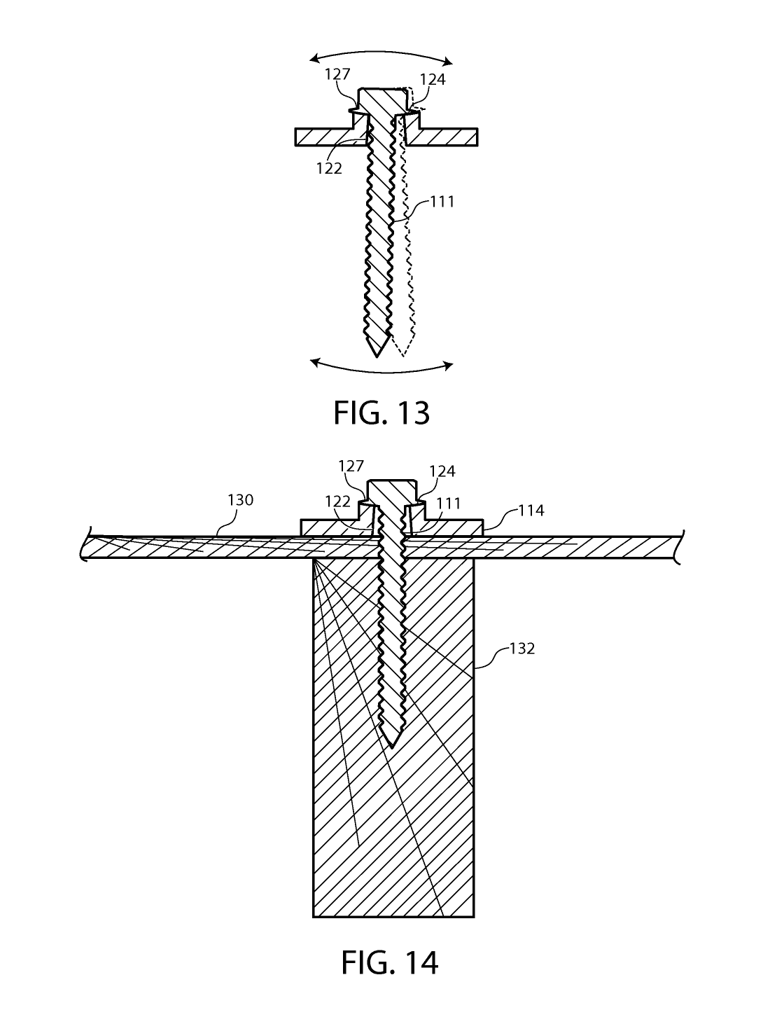

Referring to FIG. 13, the combination of the frusto-conical shape of the aperture 122 and the complementary spherical shape between the bottom surface of the collar portion 127 and seating portion 124 allows the threaded fastener 111 to freely pivot before installation while still maintaining equal pressure between the points of contact between the collar portion 127 and seating portion 124 when the threaded fastener 111 is fixed in place after installation.

FIG. 14 shows an illustrative application of the fastening device. The mounting plate 114 is mounted to a building surface 130, for example, roof sheeting or a wall. While the building surface 130 is shown as wood, the surface can also include metal roof sheeting, or other roof sheeting material. The body of the threaded fastener 111 extends through the aperture 122 into a wood beam 132 or other mounting substrate. In FIG. 14, the threaded fastener 111 is shown secured approximately normal to the plane of the building surface 130. Equal pressure is maintained at the points of contact between the collar portion 127 and seating portion 124 due to the complementary spherical surfaces of the seating portion 124 and the collar portion 127.

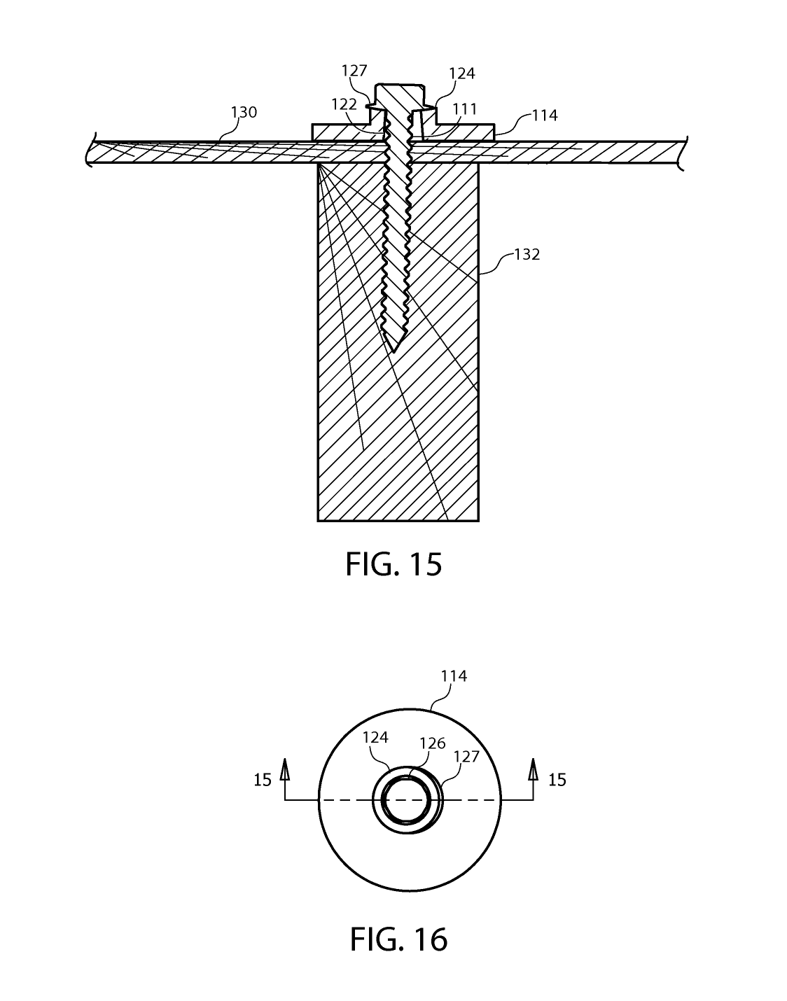

FIG. 15 shows the similar illustrated application of the fastening device of FIG. 14 where the threaded fastener 111 is shown secured at a non-normal angle with respect to the plane of the building surface 130. The frusto-conical shape of the aperture 122 allows the threaded fastener 111 to engage both the building surface 130 and the wood beam 132 at an angle non-normal to surface of the wood beam 132 and building surface 130 without lifting or skewing the mounting plate 114. Equal pressure is maintained at the points of contact between the collar portion 127 and seating portion 124 due to the complementary spherical surfaces of the seating portion 124 and the collar portion 127.

FIG. 16 shows a top view of the fastening device of FIG. 15 showing the mounting plate 114, with the fastener head 126 and collar portion 127 offset to right with respect to the seating portion 124. The aperture 122 remains covered in this arrangement.

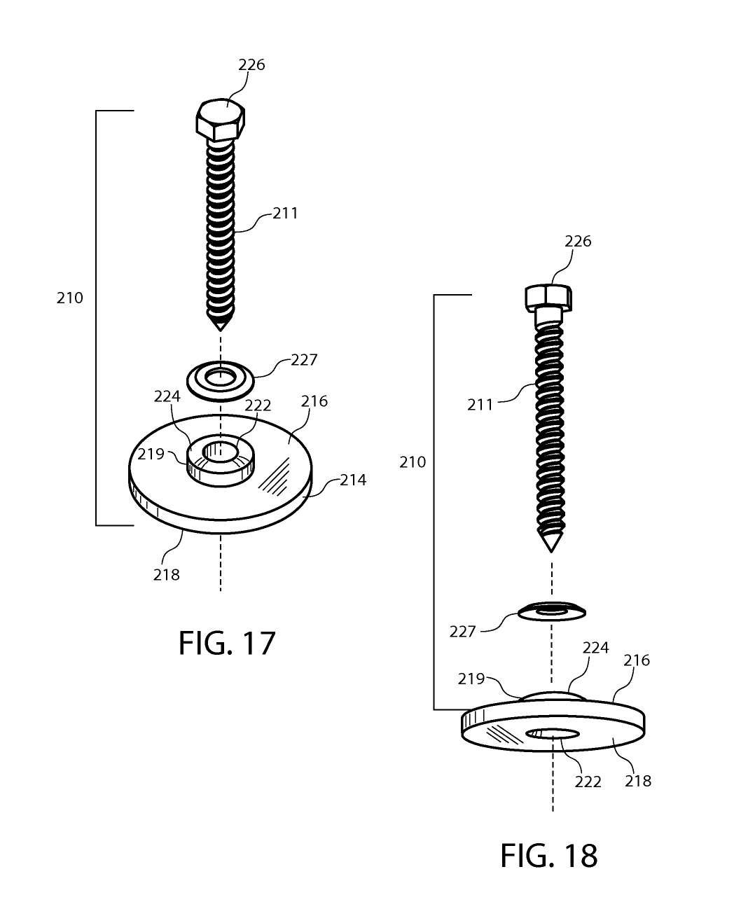

In another aspect, in FIGS. 17-24, the top surface of the projection of the mounting plate or seating portion has a convex spherical shape, as in FIGS. 1-8. In FIGS. 17-24, the collar portion is a washer. The washer can be removable. The washer can also be captively held to the threaded fastener as in an SEM fastener. The collar portion, or washer, can be metallic, elastomeric, rubber, or a combination of metal with elastomeric material on the bottom surface of the collar portion. The bottom surface of the collar portion, or washer, has a concave spherical shape that is complementary to the shape of the top surface of the projection.

FIG. 17 shows a top perspective exploded view of an embodiment of fastening device 210 that includes a threaded fastener 211 and a mounting plate 214. FIG. 18 shows a bottom perspective exploded view of the embodiment of the fastening device 210.

Referring to FIGS. 17 and 18, the mounting plate 214 includes an upper surface 216 and a lower surface 218. The upper surface 216 includes an upward projection 219. The upward projection includes an aperture 222 that is approximately centric with respect to the upward projection 219. The aperture 222 projects through the lower surface 218. The upward projection 219 includes a top surface or seating portion 224; the seating portion 224 being convex with respect to the upper surface 216 of the mounting plate 214. The shape of the seating portion 224 forms a section of a sphere. The threaded fastener 211 includes fastener head 226 and a collar portion 227. The collar portion 227, as illustrated, is in the form of a washer. As described in the preceding paragraphs referring to FIGS. 18-24, the washer, or collar portion 227, can be removable. The washer or collar portion 227 can also be captively held or joined to the threaded fastener 211, for example, as in a SEM fastener. The bottom surface of the washer or the collar portion 227 has an approximately complementary spherical shape to the seating portion 224 of the upward projection 219. The top surface of the washer or the collar portion 227, as illustrated, is flat or planar in order to evenly engage the bottom of the bottom surface of the threaded faster, which is also illustrated as planar.

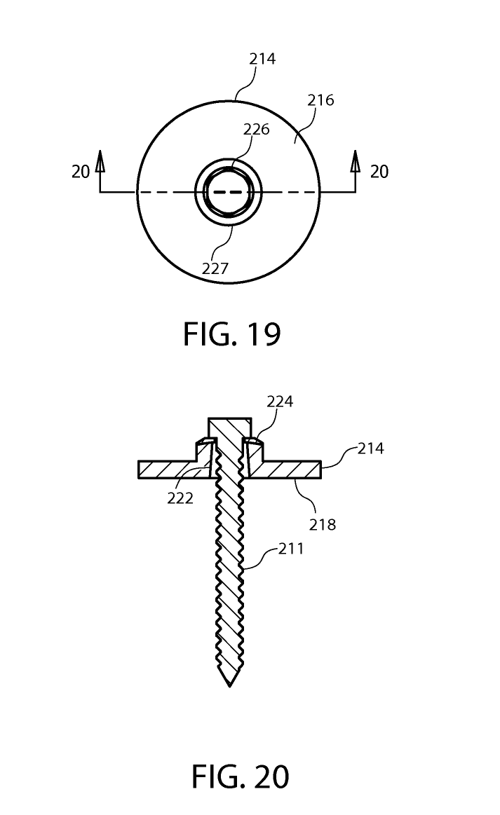

FIG. 19 shows a top view of the fastening device 210 of FIG. 18 showing the upper surface 216 of the mounting plate 214 and the fastener head 226 and the washer or the collar portion 227. FIG. 20 shows a sectional view of FIG. 19. Referring to FIG. 20, the threaded fastener 211 is shown with the threaded portion or body of the threaded fastener 211 passing through the aperture 222. The aperture 222 is approximately frusto-conical in shape with the smaller diameter opening of the aperture 222 defined by the seating portion 224 and the larger diameter opening of the aperture 222 defined by the lower surface 218 of the mounting plate 214. The aperture 222 is approximately centric with respect to the mounting plate 214.

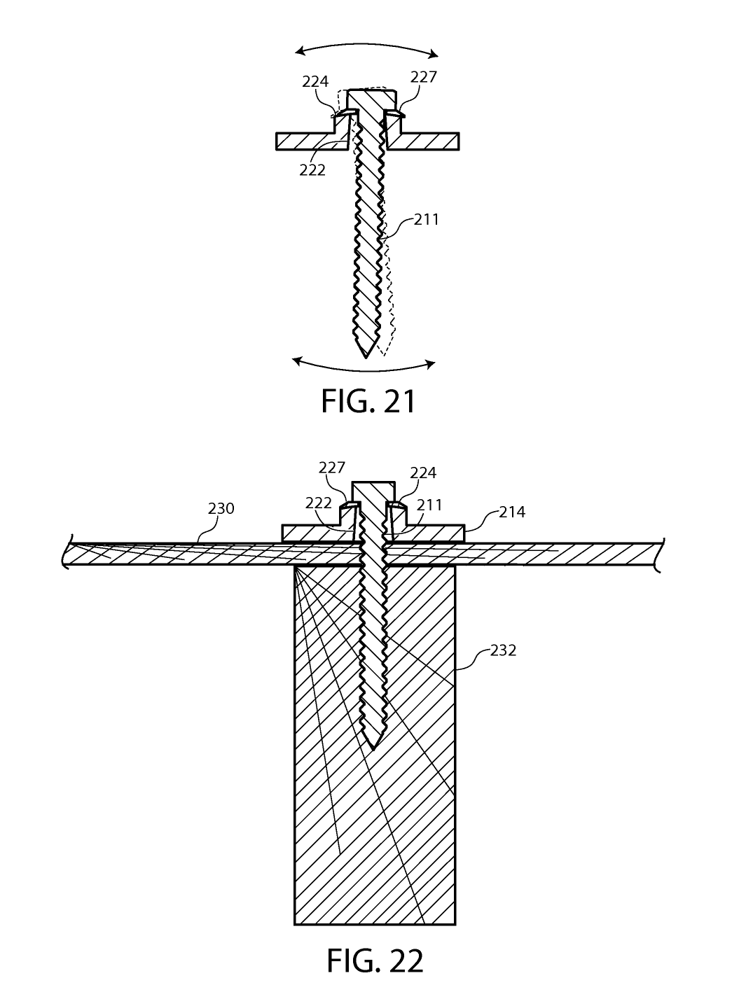

Referring to FIG. 21, the combination of the frusto-conical shape of the aperture 222 and the complementary spherical shape between the bottom surface of the washer or the collar portion 227 and seating portion 224 allows the threaded fastener 211 to freely pivot before installation while still maintaining equal pressure between the points of contact between the collar portion 227 and seating portion 224 the threaded fastener 211 is fixed in place after installation.

FIG. 22 shows an illustrative application of the fastening device. The mounting plate 214 is mounted to a building surface 230, for example, roof sheeting or a wall. While the building surface 230 is shown as wood, the surface can also include metal roof sheeting, or other roof sheeting material. The body of the threaded fastener 211 extends through the aperture 222 into a wood beam 232 or other mounting substrate. In FIG. 22, the threaded fastener 211 is shown secured approximately normal to the plane of the building surface 230. Equal pressure is maintained at the points of contact between the washer or the collar portion 227 and seating portion 224 due to the complementary spherical surfaces of the seating portion 224 and the collar portion 227.

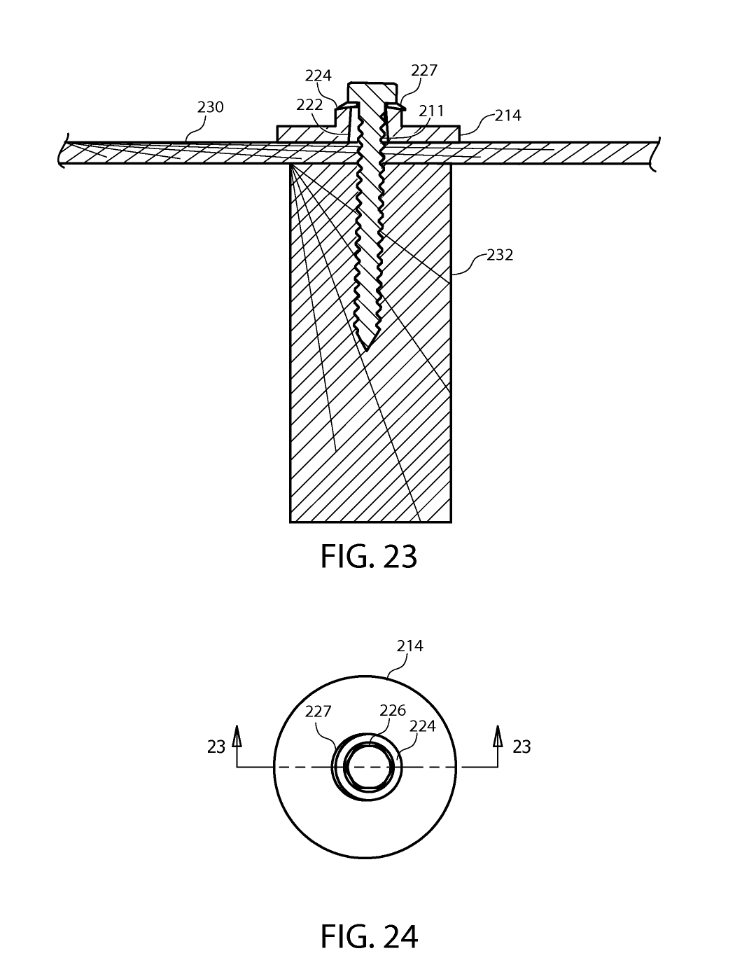

FIG. 23 shows the same illustrated application of the fastening device as in FIG. 22 except the threaded fastener 211 is shown secured at a non-normal angle with respect to the plane of the building surface 230. The frusto-conical shape of the aperture 222 allows the threaded fastener 211 to engage both the building surface 230 and the wood beam 232 at an angle non-normal to surface of the wood beam 232 and building surface 230 without lifting or skewing the mounting plate 214. Equal pressure is maintained at the points of contact between the washer or collar portion 227 and seating portion 124 due to the complementary spherical surfaces of the seating portion 224 and the collar portion 227.

FIG. 24 shows a top view of the fastening device of FIG. 23 showing the mounting plate 214, with the fastener head 226 and the washer or collar portion 227 offset to right with respect to the seating portion 224. The aperture 222 remains covered in this arrangement.

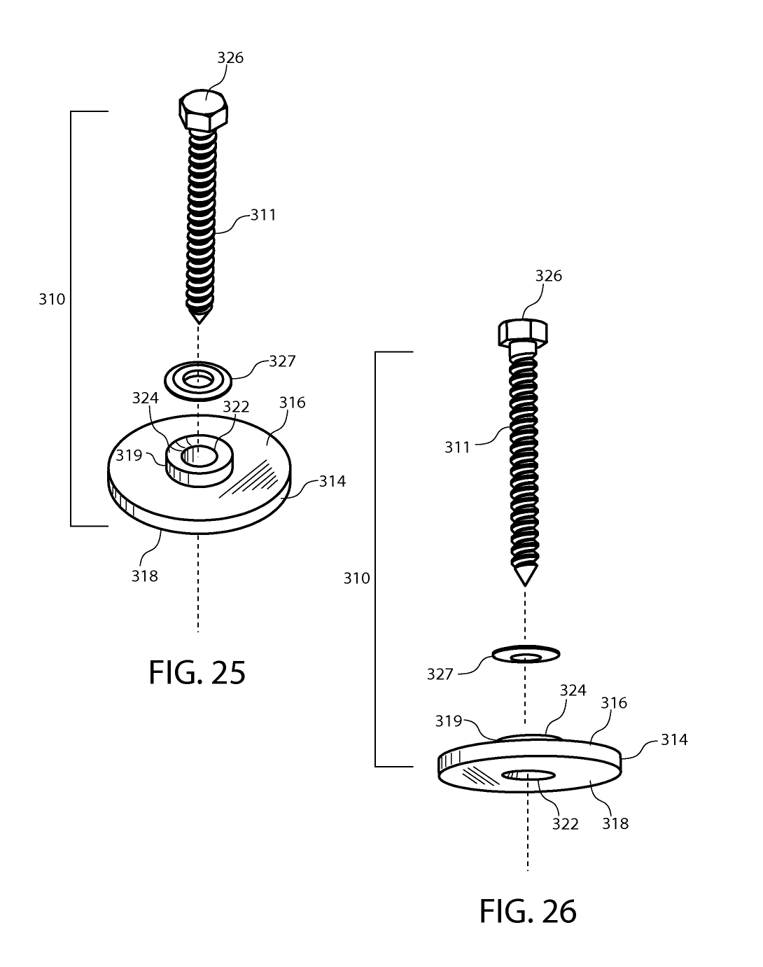

In another aspect, FIGS. 25-32 is similarly configured as FIGS. 17-24 except the top surface of the projection or seating portion has a concave spherical shape. The bottom surface of the washer or collar portion has a convex spherical shape that is complementary to the shape of the top surface of the projection.

FIG. 25 shows a top perspective exploded view of an embodiment of fastening device 310 that includes a threaded fastener 311 and a mounting plate 314. FIG. 26 shows a bottom perspective exploded view of the embodiment of the fastening device 310.

Referring to FIGS. 25 and 26, the mounting plate 314 includes an upper surface 316 and a lower surface 318. The upper surface 316 includes an upward projection 319. The upward projection includes an aperture 322 that is approximately centric with respect to the upward projection 319. The aperture 322 projects through the lower surface 318. The upward projection 319 includes a top surface or seating portion 324; the seating portion 324 being convex with respect to the upper surface 316 of the mounting plate 314. The shape of the seating portion 324 forms a section of a sphere. The threaded fastener 311 includes fastener head 326 and a collar portion 327. The collar portion 327, as illustrated, is in the form of a washer. The washer, or collar portion 227, can be removable. The washer or collar portion 227 can also be fixed in place, for example, as in a SEM fastener. The bottom surface of the washer or collar portion 327 is convex in shape and has an approximately complementary spherical shape to the seating portion 324 of the upward projection 319. The top surface of the washer or collar portion is flat or planar in order to evenly seat with the bottom surface of the threaded fastener 311, which is illustrated as planar.

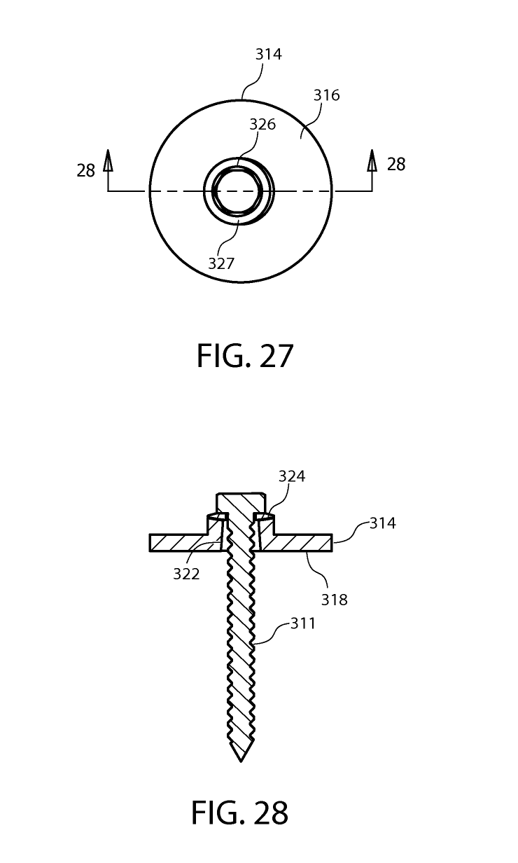

FIG. 27 shows a top view of the fastening device of FIG. 26 showing the upper surface 316 of the mounting plate 314 and the fastener head 326 and collar portion 327. FIG. 28 shows a sectional view of FIG. 27. Referring to FIG. 28, the threaded fastener 311 is shown with the threaded portion or body of the threaded fastener 311 passing through the aperture 322. The aperture 322 is approximately frusto-conical in shape with the smaller diameter opening of the aperture 322 defined by the seating portion 324 and the larger diameter opening of the aperture 322 defined by the lower surface 318 of the mounting plate 314.

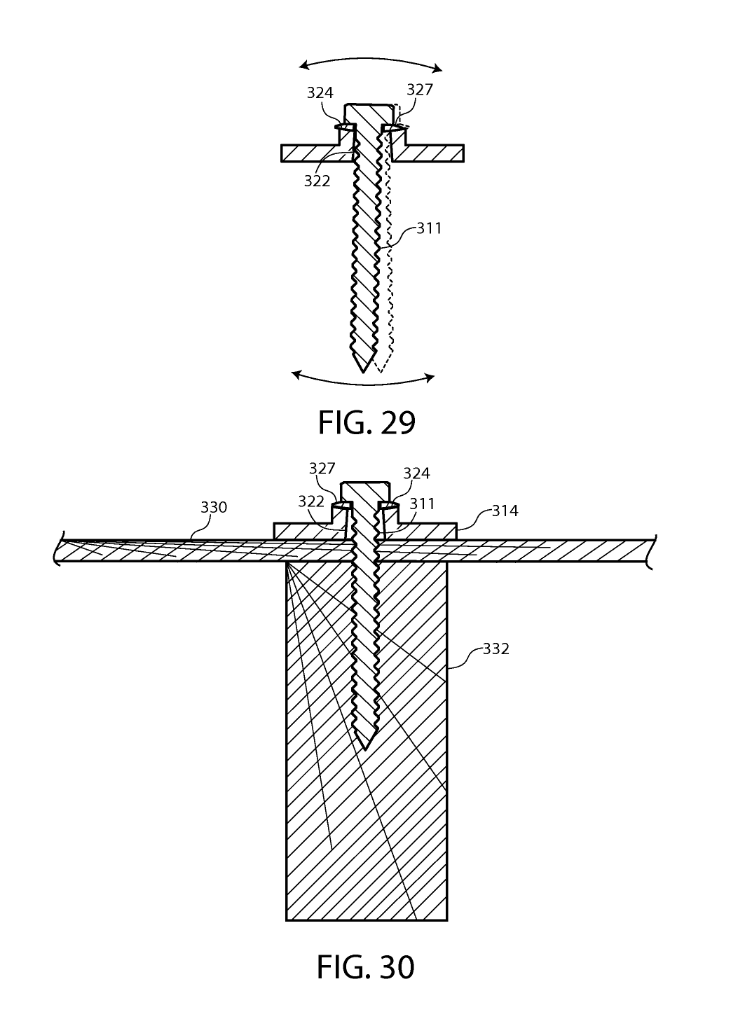

Referring to FIG. 29, the combination of the frusto-conical shape of the aperture 322 and the complementary spherical shape between the bottom surface of the washer or collar portion 327 and the seating portion 324 allows the threaded fastener 311 to freely pivot before installation while still maintaining equal pressure between the points of contact between the collar portion 327 and the seating portion 324 when the threaded fastener 311 is fixed in place after installation.

FIG. 30 shows an illustrative application of the fastening device. The mounting plate 314 is mounted to a building surface 330, for example, roof sheeting or a wall. While the building surface 330 is shown as wood, the surface can also include metal roof sheeting, or other roof sheeting material. The body of the threaded fastener extends through the aperture 322 into a wood beam 332 or other mounting substrate. In FIG. 30, the threaded fastener 311 is shown secured approximately normal to the plane of the building surface 330. Equal pressure is maintained at the points of contact between the collar portion 327 and the seating portion 324 due to the complementary spherical surfaces of the seating portion 324 and the collar portion 327.

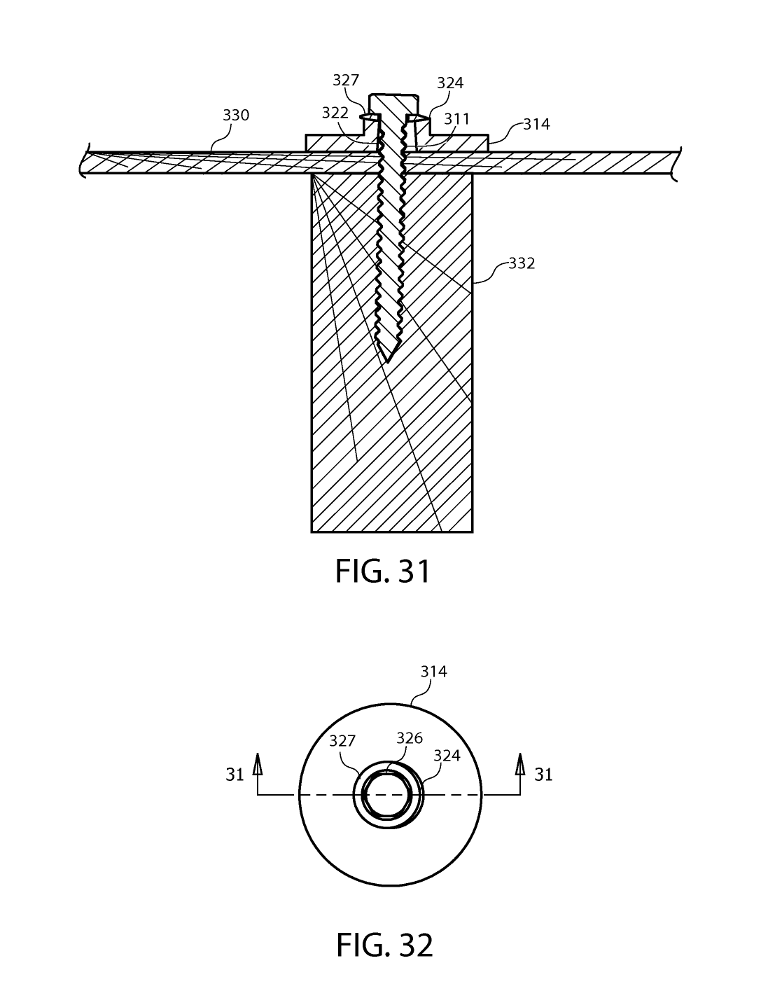

FIG. 31 shows an exemplary application of a fastening device similar to the exemplary illustration of FIG. 30 except the threaded fastener 311 is shown secured at a non-normal angle with respect to the plane of the building surface 330. The frusto-conical shape of the aperture 322 allows the threaded fastener 311 to engage both the building surface 330 and the wood beam 332 at an angle non-normal to surface of the wood beam 332 and building surface 330 without lifting or skewing the mounting plate 314. Equal pressure is maintained at the points of contact between the collar portion 327 and seating portion 324 due to the complementary spherical surfaces of the seating portion 324 and the collar portion 327.

FIG. 32 shows a top view of the fastening device of FIG. 31 showing the mounting plate 314, with the fastener head 326 and collar portion 327 offset to right with respect to the seating portion 324. The aperture 322 remains covered in this arrangement.

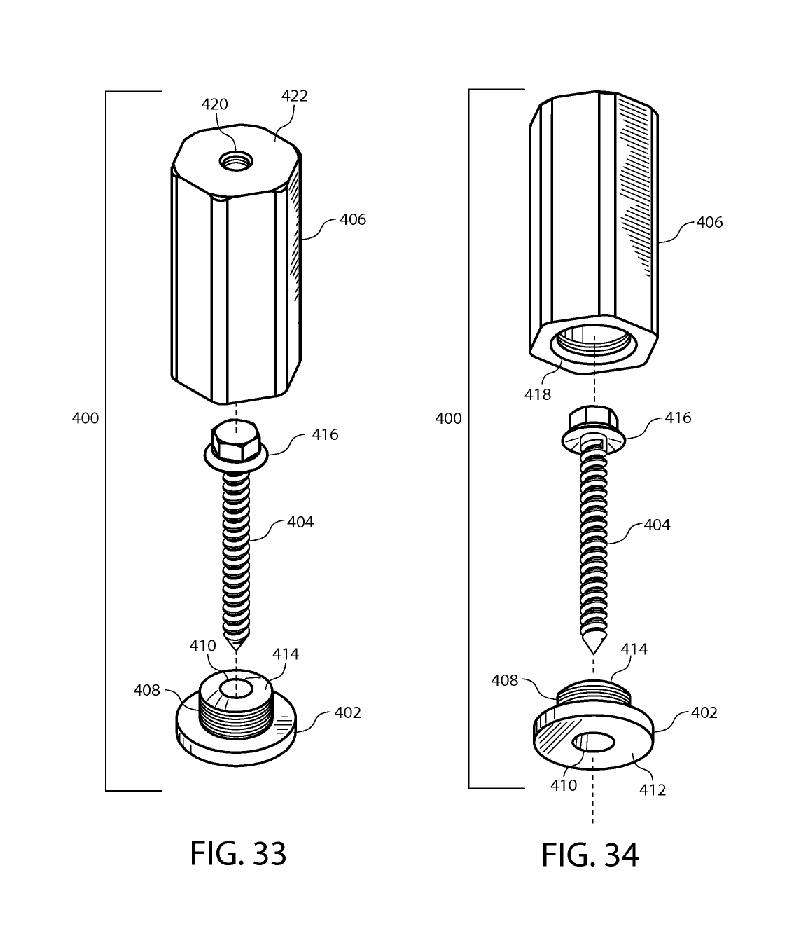

FIGS. 33-36 illustrate an exemplary embodiment of a fastening device 400 incorporated in a standoff fastener. FIG. 33 shows a top perspective exploded view of the fastening device 400. FIG. 34 shows a bottom perspective exploded view of the fastening device 400. Referring to FIGS. 33 and 34, the fastening device 400 includes a mounting plate 402, a threaded fastener 404, and a threaded standoff 406. The mounting plate 402 includes an upward projection 408. The upward projection 408 includes an area defining an aperture 410. The aperture 410 is approximately centric with respect to the upward projection 408, not threaded, and disposed to receive and seat the threaded fastener 404. The projection extends through the bottom portion 412 of the mounting plate 402. The projection includes an upper surface 414 that is spherically convex shaped.

The threaded fastener 404 includes a collar portion 416. The lower surface of the collar portion 416 is spherically concave shaped. The shape of the lower surface of the collar portion 416 is complementary to the shape of the upper surface 414 of the upward projection 408. As previously described, the collar portion can be formed or cast with the threaded fastener and can be separately formed and joined to the threaded fastener such as in an SEM fastener. The lower surface of the collar portion can include waterproof or water resistant material such as an elastomeric seal or washer where the seal or washer making contact with the upper surface 414 of the upward projection 408 has a complementary shape to the upper surface 414 of the upward projection 408.

The sidewall of the upward projection 408 is threaded. The threaded standoff 406 includes a hollow opening 418 formed on its bottom surface. The hollow opening 418 includes a threaded inner surface with complementary threading to the sidewall of the upward projection 408 so that the hollowing opening can receive and secure the upward projection 408. This arrangement can help to protect the threaded fastener 404 from the elements and help to increase water resistance.

The threaded standoff 406 also includes a threaded aperture 420 on top surface 422 of the threaded standoff 406. The top surface 422 is flat so that the top surface 422 and threaded aperture 420 in combination can fasten to a wide variety of equipment such as solar photovoltaic panels (PV), solar hot water collectors, or other roof or wall mounted equipment.

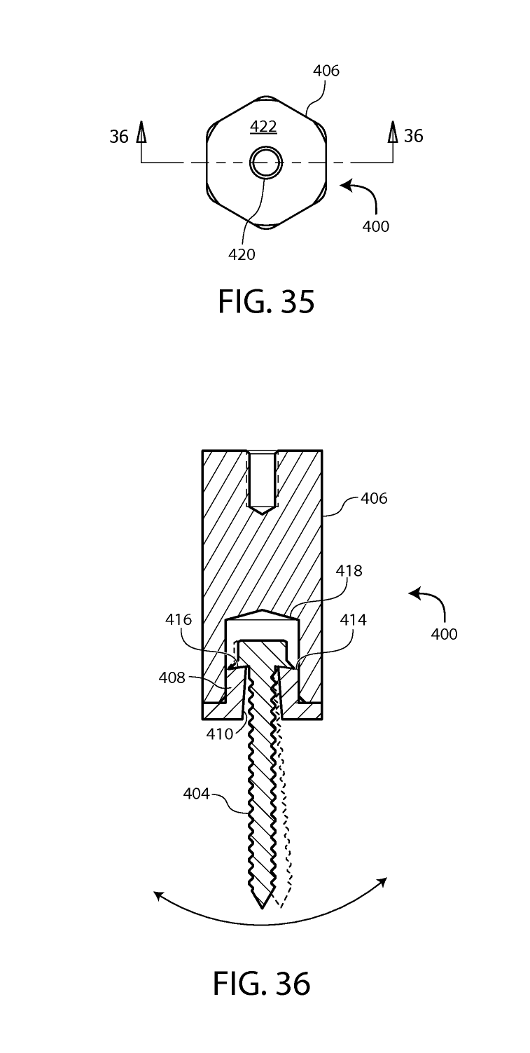

Referring to FIGS. 35 and 36, FIG. 35 shows a top view of the fastening device 400. Illustrated is the top surface 422 of the threaded standoff 406 with the threaded aperture 420. FIG. 36 shows a sectional view of FIG. 35 of the fastening device 400 of FIG. 35. Illustrated is the frusto-conical or tapered shaped of aperture 410 through the upward projection 408. The combination of the frusto-conical shape of the aperture 410 and the complementary spherical shape between the bottom surface of the collar portion 416 and the upper surface 414 of the upward projection 408 allows the threaded fastener 404 to freely pivot before installation while still maintaining equal pressure between the points of contact between the collar portion 416 and the upper surface 414 of the upward projection 408 when the threaded fastener 404 is fixed in place after installation. A hollow opening 418 in the bottom surface of the threaded standoff 406 is shaped to allow the threaded fastener 404 to freely pivot on the upper surface 414 of the upward projected 408.

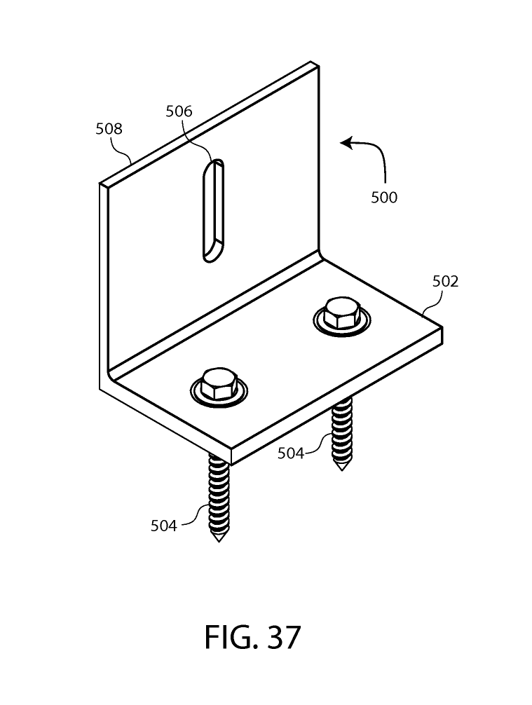

FIGS. 37-39 illustrate an exemplary embodiment of the fastening device incorporating a mounting bracket. FIG. 37 shows a front perspective view of a fastening device 500 that includes a mounting bracket 502 configured to receive one or more threaded fasteners 504. The mounting bracket 502 illustrated in FIG. 37 includes a slotted aperture 506 on the mounting bracket upper portion 508. The slotted aperture 506 can be used to engage a mounting rail with a threaded fastener, for example, as part of a solar PV panel mounting system on a rooftop. Alternatively, it could be used to mount other equipment to the bracket, which in turn can be mounted to either a roof our building wall.

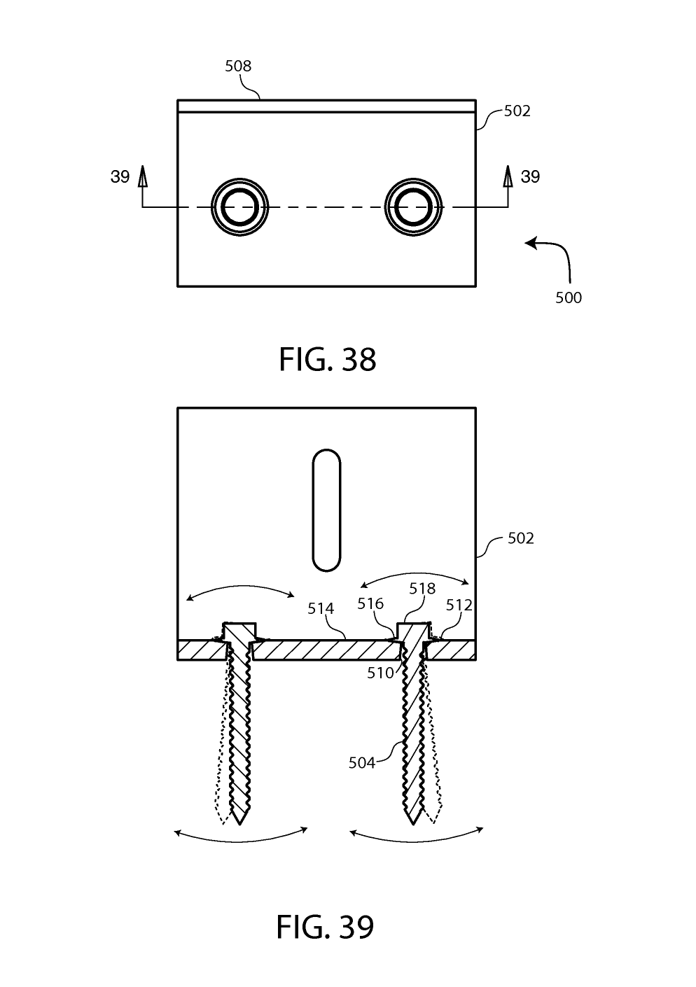

FIG. 38 shows a top view of the fastening device 500 illustrating the mounting bracket 502 and the mounting bracket upper portion 508.

FIG. 39 shows a sectional view of FIG. 38. Referring to FIGS. 39, the threaded fastener 504 passes through an aperture 510. The aperture 510 is frusto-conical in shape terminating in a spherically concave surface 512 on an upper surface 514 base portion of the mounting bracket 502. The smaller diameter opening of the aperture 510 is toward the upper surface 514. The threaded fastener 504 has a collar portion 516 surrounding and concentric with the fastener head 518. The collar portion 516 is spherically convex in shape and complementary to the shape of the spherically concave surface 512. The combination of the complementary spherically convex shape of the collar portion 516 and the spherically concave surface 512 along with the aperture 510 that is frusto-conical in shape allows the threaded fastener 504 to freely pivot before installation while still maintaining equal pressure between the points of contact between the collar portion 516 and the spherically concave surface 512 when the threaded fastener 504 is fixed in place after installation.

While FIGS. 37-39 illustrates a fastening device 500 with two fasteners. It should be readily understood to one skilled in the art that the combination of the spherically concave surface 512 and spherical convex shape of the collar portion 516 both complementary in shape to each other, along with the aperture 510 that is frusto-conically shaped is not limited to two fasteners but can be applied to one or more fasteners as required. In another aspect, the collar can be spherically concave in shape and the complementary surface instead of being a spherically concave surface 512 could be spherically convex in shape. This would produce the same effect of maintaining equal pressure between the point of contact between the collar portion 516 and the spherically concave surface 512 when the fastener is fixed in place no matter the angle that the fastener is pivoted.

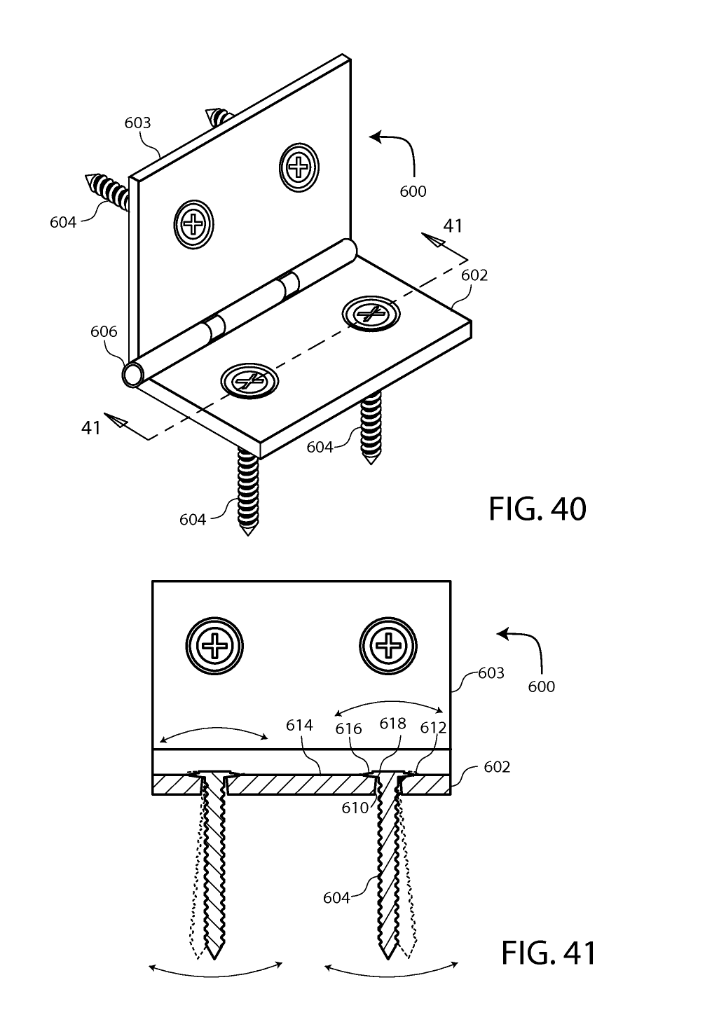

FIGS. 40 and 41 illustrates a fastening device 600 where the fastening device includes a first base plate 602 and a second base plate 603 for receiving threaded fasteners 604. The first base plate and the second base plate are hingedly connected by a hinge pin 606. FIG. 40 shows a front perspective view of the fastening device 600. FIG. 41 shows a sectional view of FIG. 40.

Referring to FIG. 41, the threaded fastener 604 passes through an aperture 610. The aperture 610 is frusto-conical in shape terminating in a spherically concave surface 612 on an upper surface 614 base portion of the first base plate 602. The smaller diameter opening of the aperture 610 is toward the upper surface 614. The threaded fastener 604 has a collar portion 616 surrounding and concentric with the fastener head 618. The collar portion 616 is spherically convex in shape and complementary to the shape of the spherically concave surface 612. The combination of the complementary spherically convex shape of the collar portion 616 and the spherically concave surface 612 along with the aperture 610 that is frusto-conical in shape allows the threaded fastener 604 to freely pivot before installation while still maintaining equal pressure between the points of contact between the collar portion 616 and the spherically concave surface 612 when the threaded fastener 604 is fixed in place after installation.

The second base plate 603 includes frusto-conical apertures and spherically concave surfaces configured similarly to those of the first base plate.

A fastening device has been described. It is not the intent of this disclosure to limit the claimed invention to the examples, variations, and exemplary embodiments described in the specification. Those skilled in the art will recognize that variations will occur when embodying the claimed invention in specific implementations and environments. For example, it is possible to implement certain features described in separate embodiments in combination within a single embodiment. Similarly, it is possible to implement certain features described in single embodiments either separately or in combination in multiple embodiments. It is the intent of the inventor that these variations fall within the scope of the claimed invention. While the examples, exemplary embodiments, and variations are helpful to those skilled in the art in understanding the claimed invention, it should be understood that, the scope of the claimed invention is defined solely by the following claims and their equivalents.

What is claimed is:

1. A fastening device, comprising:
a threaded fastener including a fastener head and a collar portion outwardly concentric to the fastener head, the collar portion having a bottom surface shaped in as a section of a spherical surface;
a mounting plate, including an upper surface, a lower surface, a portion forming a frusto-conical aperture through the upper surface and the lower surface for receiving the thread fastener, the frusto-conical aperture having a larger diameter opening on the lower surface and a smaller diameter opening on the upper surface; and
the upper surface of the mounting plate further including a seating portion outwardly concentric to the smaller diameter opening, the seating portion shaped in form of a spherical section and having a complementary shape to the bottom surface of the threaded fastener.

2. The fastening device of claim 1, wherein the seating portion is spherically convex shaped and the bottom surface of the collar portion is spherically concave shaped.

3. The fastening device of claim 2, wherein the collar portion is an integrally formed portion of the threaded fastener.

4. The fastening device of claim 2, wherein the collar portion is separately formed but captively held to the threaded fastener.

5. The fastening device of claim 1, wherein the seating portion is spherically concave shaped and the bottom surface of the collar portion is spherically convex shaped.

6. The fastening device of claim 5, wherein the collar portion is an integrally formed portion of the threaded fastener.

7. The fastening device of claim 5, wherein the collar portion is separately formed but captively held to the threaded fastener.

8. The fastening device of claim 5 further including:
a hinge pin;
the mounting plate is a first mounting plate and a second mounting plate; and
the first mounting plate and second mounting plate are hingedly joined by the hinge pin.

9. The fastening device of claim 1, wherein:
the mounting plate further includes an upward projection outwardly concentric to the frusto-conical aperture;
the upward projection including a top surface; and
the top surface including the seating portion.

10. The fastening device of claim 9, wherein the seating portion is spherically convex shaped and the bottom surface of the collar portion is spherically concave shaped.

11. The fastening device of claim 9, wherein the seating portion is spherically concave shaped and the bottom surface of the collar portion is spherically convex shaped.

12. The fastening device of claim 1, wherein the mounting plate is an L-bracket.
